(19) United States
(12) Patent Application Publication
(10) Pub. No.: US 2026/0165355 A1
(43) Pub. Date: Jun. 18, 2026

(54) Boil Over Reduction Compositions for Microwave Cooking

(71) Applicant: General Mills, Inc., Minneapolis, MN (US)

(72) Inventors: Colby Darling, Minneapolis, MN (US); Victor Kurtis Villwock, Hudson, WI (US); Michelle Waldhauser, Savage, MN (US)

(73) Assignee: General Mills, Inc., Minneapolis, MN (US)

(21) Appl. No.: 18/706,033

(22) PCT Filed: Oct. 27, 2022
(86) PCT No.: PCT/US2022/047993

§ 371 Date: Apr. 30, 2024

Related U.S. Application Data
(60) Provisional application No. 63/278,279, filed on Nov. 11, 2021.

(51) Int. Cl. A23L 29/212; A23L 5/10; A23L 7/109; A23L 7/196; A23L 19/00; A23L 27/40; A47J 36/02; B65D 81/34

(52) U.S. Cl. CPC A23L 29/212; A23L 5/15; A23L 7/109; A23L 7/196; A23L 19/01; A23L 27/40; A47J 36/027; B65D 81/3446; B65D 2581/3404; B65D 2581/3432

(57) ABSTRACT

An anti-boil-over composition comprising about 30% to about 60% powdered cauliflower or powdered pea fiber is added to dried rice or dried pasta within a container suitable for cooking in a microwave upon further adding water into the container. The amount of composition employed constitutes about 5% to about 13%, by weight, of the dried rice or dried pasta and can additionally include about 10% to about 45% purified starch, about 5% to about 10% fat, and up to 6% sodium chloride, potassium chloride and/or calcium chloride. A shelf stable food product including the anti-boil-over composition and a method of preparing the shelf stable food product are also encompassed.

### FIELD OF THE INVENTION

The invention generally pertains to microwave cooking and, more particularly, to compositions used to reduce boil over when cooking using microwaves. The invention also extends to microwavable high water content food products which are shelf stable and incorporate the anti-boil-over compositions and methods of preparing the microwavable high water content food products.

### BACKGROUND OF THE INVENTION

Due to the time demands placed on consumers by the everyday activities of modern life, the preparation of food products and meals from scratch has decreased and the popularity of premade or partially premade food products has increased dramatically. In addressing the time demands, many of these premade food products are designed to be heated using microwave energy. However, when foods with rather high water content, for example dried pasta products to which water is added, are microwaved, boil-over (i.e., the occurrence of water heated by the microwaves boiling and spilling out of the cup) of the liquid component of the food product is a commonly occurring problem. If the same product were to be cooked on a stovetop, boil-over can be easily prevented by simply monitoring of the cooking operation and lowering of the heat output when the condition arises. Stirring of the food being cooked can also avoid boil-over conditions. However, these options are simply not available in connection with microwave cooking as the microwave cooking process is not readily apparent.

The issue of boil-over certainly results in the need to clean the microwave cavity of the resulting, often sticky, overflow. However, more importantly, boil-over changes the ingredient ratios and compromises the taste and texture of the finished product, resulting in reduced customer satisfaction. One proposed solution to this recognized problem is employing packaging and cooking containers which are significantly oversized in order to contain the liquid and prevent boil-over. Simply stated, this potential solution is unsatisfactory given the significant added cost and material waste. A more appealing solution is the use of product additives, commonly modified starch compositions, to address boil-over. However, there are significant problems with current proposed solutions. In particular, there is a high rate of failure with currently proposed product additives such that these proposals are simply not reliable. In addition, these product additive proposals are just not desirable by clean label brands, thereby not representing viable solutions over the range of products facing boil-over problems.

### SUMMARY OF THE INVENTION

The present invention provides for the addition of specific anti-boil-over compositions to high water content foods which are intended to be cooked via microwaves. Of particular concern are high water content foods such as dried rice and dried pasta to which is directly added water or a high water content sauce prior to cooking through the use of microwaves. The anti-boil-over compositions of the invention are designed to reduce boil-over by thickening the existing liquid, slowing the product temperature rise during microwaving and/or establishing nucleation sites.

More specifically, the invention employs powdered cauliflower and/or powdered pea fiber as an anti-boil-over additive. In accordance with a preferred form of the invention, the anti-boil-over composition comprising about 30% to about 60% powdered cauliflower or powdered pea fiber. In certain embodiments, additional ingredients can be incorporated into the composition. For instance, one variation of the composition also includes about 10% to about 45% purified starch, about 5% to about 10% fat, and up to 5% sodium chloride, potassium chloride, or calcium chloride. Although other substitutions could be employed, the purified starch is preferably constituted by tapioca starch or corn starch, the fat by coconut oil, and the chloride obtained from table or sea salt.

In a particularly preferred form of the invention, the anti-boil-over composition of the invention consists of 30-60% powdered cauliflower or powdered pea fiber, 10% to 45% purified starch, 5% to 10% fat, and 1% to 3% table salt or sea salt. Overall, the invention encompasses the anti-boil-over composition, as well as a microwaveable high water content food product which is shelf stable and incorporates the anti-boil-over composition and a method of preparing the microwavable high water content food product including the composition wherein, in each case, an effective amount of the anti-boil-over composition is provided to significantly reducing boil-over when the food product is cooked with microwave heating relative to cooking the food product in the same manner without the anti-boil-over composition.

Additional objects, features and advantages of the invention will become more readily apparent based on the following detailed description of preferred embodiments of the invention.

### DETAILED DESCRIPTION OF INVENTION

Many consumers rely on microwave ovens for addressing the need to quickly heating various food products, including a host of pasta and rice food products. By way of example, it is known for noodle soups, macaroni & cheese, and various other pasta and rice based food products to be sold in appropriately sized containers, just requiring a consumer to peal off a lid, potentially remove a flavor packet, add water to a designated fill line, cover the container, microwave the product in the container (perhaps with an intermediate stirring step) and mix the contents of any removed flavor packet to the product in quickly producing a satisfying hot meal. As boil-over among such commercially available products is known, reducing or eliminating this problem is the focus of this invention.

In searching for a solution, a series of tests were conducted on shelf stable, microwavable pasta food products, specifically at microwave wattages of 700W, 1000W and 1200W, with these tests indicating a host a reasons for boil-over problems. For instance, there were found to be significant variations in the water level introduced by consumers. More specifically, it was found that, on average, an additional 3 grams of water, equating to a standard deviation between target fill and average fill weights of 13 grams, was added beyond a target weight associated with the fill line. In addition, it was determined that even a 2 gram difference in the amount of pasta introduced into the container during production had a significant impact on boil-over. Rather surprisingly, reducing the cook time up to 25% did not significantly impact boil-over. In addition, it was found that the type of pasta or rice can affect boil-oven, e.g., whole wheat pasta will boil-over a higher percentage of the time than conventional pasta. Without any desire to negatively impact flavor, appearance and shelf-life, considered solutions included studying potential product formula, packaging and consumer preparation instruction changes. However, after considerable experimentation, the focus became the addition of an anti-boil-over composition to the food product. In considering the viability of any product additive, it was determined that, based on the products potentially being modified, any ingredients having artificial colors or flavors, synthetic preservatives, genetically modified ingredients, as well as a host of other ingredients including cocoa, dairy, palm, canola, tomatoes, eggs, fish, poultry, ruminants and pork, were automatically eliminated.

After considerable analysis, main criteria of focus became thickening the existing liquid, slowing the product temperature rise during microwaving and/or establishing nucleation sites. Certainly, a thicker liquid would be less likely to boil to the extent to spill over the upper opening of a container during microwave cooking; preparing a product whose temperature rise was slower would be less likely to boil-over during a given cooking period; and establishing nucleation sites to assist in the physical separation of different states of matter created during the cooking operation. Having the knowledge of the unsatisfactory performance of starch based anti-boil-over compositions (i.e., compositions with at least 50% starch), this criteria for the present invention was specifically avoided. After experimenting with a host of vegetable, protein and fiber sources, it was surprisingly found that only two base components functioned effectively, i.e., cauliflower and pea fiber, out of a wide range of other ingredients tested, particularly asparagus, artichoke, chickpea, pea protein, faba bean fiber, mung bean protein, inulin fiber, citrus fiber, rice fiber, oat fiber, and sugarcane fiber.

Further evaluation identified sought after results with about 30% to about 60% powdered cauliflower or powdered pea fiber, with this amount establishing an effective anti-boil-over composition capable of reducing or eliminating boil-over when dried rice or dried pasta is cooked in water in a limited volume container with microwave oven heating relative to cooking the dried rice or dried pasta in the same manner in the limited volume container without the anti-boil-over composition. As used herein, the term “limited volume container” encompasses a container for the product which is not enlarged to increase its headspace from the container employed before the addition of the composition, i.e., headspace is maintained generally less than 5 cm and preferably about 3.5 cm. In addition to the powdered cauliflower or powdered pea fiber, the composition can include other ingredients to further increase factors of the above mentioned criteria. In particular embodiments of the invention, these additional ingredients include about 10% to about 45% purified starch, about 5% to about 10% fat, and up to 6% sodium chloride, potassium chloride and/or calcium chloride, with the purified starch preferably comprising tapioca starch and/or corn starch and the fat preferably comprising coconut oil. By way of a particular example, a composition embodiment of the invention particularly found to essentially eliminate boil-over in connection with a tested Annie's Homegrown™ microwavable macaroni & cheese product is set forth in Table I.

TABLE I

| | Formulation |
|---|---|
| Ingredient | Percentage |
| Organic Cauliflower | 48.00% |
| Organic Tapioca Starch | 25.00% |
| Organic Corn Starch | 14.10% |
| Organic Coconut Oil | 7.30% |
| Fine Gran Sodium Chloride | 2.60% |
| Potassium Chloride | 3.00% |
| Total | 100.00% |

In another preferred embodiment of the invention, the anti-boil-over composition consists essentially of:
a. 30-60% powdered cauliflower or powdered pea fiber,
b. 10% to 45% purified starch,
c. 5% to 10% fat, and
d. 1% to 3% table salt or sea salt.

In connection with the shelf stable food product incorporating the anti-boil-over composition of the invention, it is preferable to simply add the composition within the container atop the dried rice (including par-boiled rice) or pasta. Utilizing the same microwavable macaroni & cheese product discussed above, during manufacturing, the composition is added within the container atop the dried pasta before the cheese flavoring packet is placed in the container and the lid is sealed. After considerable testing, the amount of composition needed to be added relative to the percentage, by weight, of the dried rice or dried pasta to appropriately address the boil-over issue was determined. One particularly identified formula resulted in a consumer product embodiment having the approximate percentages set forth in Table II.

TABLE II
Microwave Cup Formula:

| | |
|---|---|
| Pasta: | 76% |
| Cheese: | 14.5% |
| Anti-Boil Blend: | 9.5% |

Before microwaving the product, the lid is partially peeled back and the flavoring packet is removed. Thereafter, the requisite amount of water is added directly upon the anti-boil-over composition and the pasta to the designated fill line. After microwaving, the flavoring packet is stirred with the cooked pasta and, after waiting for any prescribed period of time to allow the seasoning to melt, the product can be stirred until the sauce is smooth and creamy and then it is ready for consumption.

Through the experiments conducted, it was shown that products made employing dried rice require a slightly higher percentage of the anti-boil composition than dried pasta based products. For instance, 6% of the anti-boil composition in the overall cup formula was unsatisfactory for its intended purpose when used with rice, while 9% or more performed as desired. Overall, composition percentages for the powdered rice and powdered pasta ranges from at least 5% to above 13%, with a more preferred range being 6-13%. As for the powdered cauliflower and powdered pea fiber, readily available products on the market can be suitably used. For example, cauliflower powder by BCFOODS, MILNE and SILVA are suitable. Although not an absolute requirement, in general, the powdered cauliflower is sized to pass through a #60 mesh screen or, as with the case of the MILNE product, at least 95% passes through a #40 mesh screen. An exemplary powdered pea fiber is available from the Hengyuan Biotechnology Company which offers powdered pea fiber of 80-100 mesh.

In general, it should be recognized that the invention outlines the effective use of about 30% to about 60% powdered cauliflower or powdered pea fiber in an anti-boil-over composition suitable for use in cooking dried rice or dried pasta in a microwave oven. Certainly, the implementations described above and other implementations are within the scope of the following claims. Still, one skilled in the art will appreciate that the present disclosure can be practiced with embodiments other than the exemplary ones disclosed. Therefore, the disclosed embodiments are presented for purposes of illustration and not limitation.

1. An anti-boil-over composition suitable for use in cooking dried rice or dried pasta in a microwave oven, said composition comprising about 30% to about 60% powdered cauliflower or powdered pea fiber, wherein an effective amount of the anti-boil-over composition is configured to reduce or eliminate boil-over when dried rice or dried pasta is cooked in water in a limited volume container with microwave oven heating relative to cooking the dried rice or dried pasta in the same manner in the limited volume container without the anti-boil-over composition.

2. The anti-boil-over composition of claim 1, wherein the composition additionally comprises about 10% to about 45% purified starch, about 5% to about 10% fat, and up to 6% sodium chloride, potassium chloride and/or calcium chloride.

3. The anti-boil-over composition of claim 2, wherein the purified starch comprises tapioca starch and/or corn starch.

4. The anti-boil-over composition of claim 2, wherein the fat comprises coconut oil.

5. The anti-boil-over composition of claim 1, wherein the composition consists essentially of:
a. 30-60% powdered cauliflower or powdered pea fiber,
b. 10% to 45% purified starch,
c. 5% to 10% fat, and
d. 1% to 3% table salt and/or sea salt.

6. A shelf stable food product comprising:
a. dried rice or dried pasta;
b. an effective amount of an anti-boil-over composition suitable for use in cooking dried rice or dried pasta in a microwave oven, said composition comprising about 30% to about 60% powdered pea fiber, wherein the effective amount of the anti-boil-over composition is configured to reduce or eliminate boil-over when dried rice or dried pasta is cooked in water in a limited volume container with microwave oven heating relative to cooking the dried rice or dried pasta in the same manner in the limited volume container without the anti-boil-over composition; and
c. a limited volume microwavable container containing the composition and the dried rice or dried pasta.

7. The shelf stable food product of claim 6, wherein the effective amount comprises about 5% to about 13% by weight of the dried rice or dried pasta.

8. The shelf stable food product of claim 6, wherein the dried rice is a par-boiled rice.

9. The shelf stable food product of claim 6, wherein the composition additionally comprises about 10% to about 45% purified starch, about 5% to about 10% fat, and up to 6% sodium chloride, potassium chloride and/or calcium chloride.

10. The shelf stable food product of claim 9, wherein the purified starch comprises tapioca starch and/or corn starch.

11. The shelf stable food product of claim 9, wherein the fat comprises coconut oil.

12. The shelf stable food product of claim 6, wherein the composition consists essentially of:
a. 30-60% powdered cauliflower or powdered pea fiber,
b. 10% to 45% purified starch,
c. 5% to 10% fat, and
d. 1% to 3% table salt and/or sea salt.

13. The shelf stable food product of claim 6, further comprising a flavor or seasoning in a separate package sealed within the container.

14. The shelf stable food product of claim 13, wherein each of the dried rice or dried pasta, the composition and the separate package are sealed inside of the container.

15. A method of preparing a shelf stable food product suitable for cooking in a microwave oven comprising:
adding dried rice or dried pasta to a limited volume container;
adding an effective amount of an anti-boil-over composition suitable for use in cooking dried rice or dried pasta in a microwave oven, said composition comprising about 30% to about 60% powdered pea fiber, wherein the effective amount of the anti-boil-over composition is configured to reduce or eliminate boil-over when dried rice or dried pasta is cooked in water in a limited volume container with microwave oven heating relative to cooking the dried rice or dried pasta in the same manner in the limited volume container without the anti-boil-over composition; and
sealing the dried rice or dried pasta, along with the composition, within the container.

16. The method of claim 15, wherein adding the effective amount of the anti-boil-over composition includes adding the composition to about 5% to about 13%, by weight, of the dried rice or dried pasta.

17. The method of claim 15, wherein adding the effective amount of the anti-boil-over composition includes additionally adding about 10% to about 45% purified starch, about 5% to about 10% fat, and up to 6% sodium chloride, potassium chloride and/or calcium chloride.

18. The method of claim 15, wherein adding the effective amount of the anti-boil-over composition consists essentially of adding only:
a. 30-60% powdered cauliflower or powdered pea fiber,
b. 10% to 45% purified starch,
c. 5% to 10% fat, and
d. 1% to 3% table salt and/or sea salt.

19. The method of claim 15, further comprising sealing a flavor or seasoning in a separate package within the container.
